(19) United States
(12) Patent Application Publication
(10) Pub. No.: US 2026/0004626 A1
(43) Pub. Date: Jan. 1, 2026

(54) Opening a Physical Space with a Digital Wallet

(71) Applicant: Ramsee 1 LLC, New York, NY (US)

(72) Inventors: Alan RECHTSCHAFFEN, New York, NY (US); Miera RECHTSCHAFFEN, New York, NY (US)

(21) Appl. No.: 19/250,412

(22) Filed: Jun. 26, 2025

Related U.S. Application Data
(60) Provisional application No. 63/665,045, filed on Jun. 27, 2024.

(51) Int. Cl. G07C 9/29; G06Q 30/0226

(52) U.S. Cl. CPC G07C 9/29; G06Q 30/0232

(57) ABSTRACT

A system having a processor configured to process, based on signals received from a digital wallet of a user, a digital currency unit comprising an indication of an access status associated with the digital currency unit, wherein the access status is recorded on a blockchain of the digital currency unit, process, based on signals received from the digital wallet of the user, a request to access a location controlled by the system, verify, based on the digital currency unit, the user is allowed to access the location and, when it is verified the user is allowed to access the location, generate a signal to grant the user access to the location.

### PRIORITY/INCORPORATION BY REFERENCE

This application claims priority to U.S. Provisional Application Ser. No. 63/665,045 filed Jun. 27, 2024, and entitled “Opening a Physical Space with a Digital Wallet,” the entirety of which is incorporated by reference herein.

### BACKGROUND

Customer loyalty programs are used widely across many different retail environments, e.g., grocery stores, department stores, luxury goods stores, airlines, etc. These customer loyalty programs may allow the retailer (or other entity) to provide benefits to customers. In some cases, the benefits offered to customers in the customer loyalty program may be access to exclusive goods or services in either a physical location or a virtual location. However, enforcing such access is a human intensive activity requiring centralized identity credentialing and human authentication causing issues for both the provider and the customer.

### SUMMARY

Some example embodiments are related to a system having a processor coupled to memory, the processor configured to process, based on signals received from a digital wallet of a user, a digital currency unit comprising an indication of an access status associated with the digital currency unit, wherein the access status is recorded on a blockchain of the digital currency unit, process, based on signals received from the digital wallet of the user, a request to access a location controlled by the system, verify, based on the digital currency unit, the user is allowed to access the location and, when it is verified the user is allowed to access the location, generate a signal to grant the user access to the location.

Other example embodiments are related to an apparatus having processing circuitry coupled to memory, the processing circuitry configured to receive digital currency units associated with a provider, store the digital currency units in a digital wallet and generate, for transmission to an access control system, the digital currency units and a request to allow a user of the digital wallet to access a location controlled by the access control system, wherein the digital currency units comprise an indication of an access status, wherein the access status is recorded on a blockchain of the digital currency unit.

### BRIEF DESCRIPTION OF THE DRAWINGS

FIG. 1 is a block diagram of an example system according to various example embodiments.

FIG. 2 illustrates the distribution of the cryptocurrency to qualified customers of a customer loyalty program according to various example embodiments.

FIG. 3 illustrates a block diagram for using the cryptocurrency to access a physical space according to various example embodiments.

FIG. 4 is a block diagram of a special purpose computer system on which various functions discussed herein may be practiced according to various example embodiments.

FIG. 5 shows an example of a token blockchain according to various example embodiments.

FIG. 6 shows an example of a token blockchain transfer according to various example embodiments.

### DETAILED DESCRIPTION

The example embodiments may be further understood with reference to the following description and the related appended drawings, wherein like elements are provided with the same reference numerals. The example embodiments relate to using cryptocurrency tokens for security and identity management of a customer in a customer loyalty program for the purpose of granting the customer access to a physical location.

Cryptocurrency may be a digital asset that operates in the same manner as fiat currency, e.g., cryptocurrency may represent value that may be used to acquire goods and services. The cryptocurrency may be an open ecosystem entity such as bitcoin that may be accepted by multiple entities that sell goods or services. The cryptocurrency may also be a closed ecosystem, e.g., a larger retailer may issue a cryptocurrency that may only be exchanged for goods and services at the retailer. There may also be hybrid cryptocurrencies that are somewhere between a fully open ecosystem and a closed ecosystem.

The example embodiments are described with reference to an example cryptocurrency where record keepers generate hash values when a transaction occurs and if approved a “block” is created to add to a distributed ledger that may be used to validate exchanges and/or other operations. A blockchain is a chain of these entries and is, in essence, the ledger itself. The blockchain is supported across multiple computers (nodes) that are linked in a peer-to-peer network. Blockchain technology is designed to solve the “trust problem.” It creates a verifiable ledger that no one node may compromise. It is transparent, time-stamped and decentralized. The example embodiments make use of the blockchain technology to solve the issues related to access to physical locations (e.g., doors, drawers, display cases, etc.). In the example embodiments, a unit or units of the cryptocurrency may be referred to as “tokens” or “coins.” Thus, throughout this description, the terms cryptocurrency, tokens or coins may be used interchangeably.

The following provides a description of an example cryptocurrency that may be used to implement the example embodiments. However, it should be understood that the example embodiments are not limited to use with the described cryptocurrency, e.g., those skilled in the art will understand how to apply the example embodiments to any cryptocurrency scheme.

Cryptocurrencies typically use blockchain technology to encrypt the cryptocurrency. For example, in some blockchain technologies, the data associated with a new transaction becomes a new block. This block has a cryptographic hash that includes information that may link the block to the most recent block in the blockchain, a time of the transaction, and a record of transaction information. The blocks of a blockchain may link in chronological order and be recorded in a distributed ledger. Each coin or token of the cryptocurrency may include this blockchain information that uniquely identifies the coin or token.

In the example embodiments, the blocks may be extended to include information related to physical access to a location. In some example embodiments, the physical access may be related to a customer loyalty program. For example, this information may include the status of the customer in a customer loyalty program (e.g., gold status, silver status, etc.), an identification of a benefit (e.g., access to a location) to which the holder of the coin is entitled, etc. In another example, this information may include the benefit itself (e.g., the access to a specific location). For example, the simple fact that a user has a particular token in their digital wallet may entitle the user to access a particular location.

The example embodiments provide a specific blockchain architecture that embeds benefit information and/or loyalty status metadata directly into the distributed ledger blocks—creating a technically improved blockchain that solves the technical problem of status verification without centralized authority, e.g., the tokens themselves are the benefit indication. This allows for real-time technical verification of user access to a physical/virtual location by parsing blockchain-embedded benefits, eliminating the technical bottleneck of human verification systems. The example embodiments create a technically superior architecture where possession of the properly formatted token is the verification mechanism for access to the benefit.

In some example embodiments, a gateway token may be used to identify the loyalty status of customer, which in turn, may control access to the benefit (e.g., access to a physical location or other type of benefit), e.g., what physical locations is this customer allowed to access based on their customer loyalty program status. This information may be securely recorded on the blockchain of the gateway token.

Reward token(s) may directly record the benefit (e.g., access to the physical location) to which possession of the reward token entitles the customer, e.g., the customer may exchange reward token(s) for access to a physical location.

Thus, in the above examples, the reward tokens or the gateway tokens may record an access status on the blockchain. For example, in the example of the gateway tokens, the access status may correspond to the loyalty status recorded on the blockchain. In the example of the reward tokens, the access status may be directly recorded on the blockchain. In either example, a number of gateway/reward tokens may correspond to an access status.

To provide a non-limiting example that may be applicable to both the gateway token and/or reward token scenario, a retailer may have a physical location (e.g., brick and mortar store) that any customer may enter. This public area may have certain goods for sale to all customers. There may also be three (3) private rooms inside the store. Each of these private rooms may have different goods for sale to only those customers that have access to the particular private room. For example, the first room may be a “silver” room and only those customers that have gateway token(s) indicating the silver level of loyalty status or customers that have reward token(s) indicating “silver” access may access the “silver” room. The other rooms may be a “gold” room and a “platinum” room and only the customers with the appropriate gateway tokens or reward tokens may access these rooms.

In the example embodiments, the gateway tokens and the reward tokens are described as separate tokens, e.g., a customer may have a gateway token that indicates the loyalty status of the customer and one or more reward tokens that may be exchanged for benefits. However, the example embodiments are not limited to the scenario where the gateway tokens and the reward tokens are separate. There may be example embodiments where the information related to loyalty status and reward status are recorded in the same token(s), e.g., each of the customer's tokens include a recording of the loyalty status. Thus, throughout this description, whenever a gateway token and/or reward token is described, it should be understood that the tokens may be tokens with a separate functionality, e.g., loyalty or reward, or single token(s) with both functionalities.

The use of the tokens decouples the status (and associated benefits) from the user account, e.g., the simple fact that the customer has the token with the related status indicates to the provider of the goods and services that the customer is entitled to the benefits associated with the status (e.g., access to the location). This also relieves the customer of having to remember/save credential information such as username and password information and also prevents this type of credential information from being stolen in an identity theft. The cryptocurrency token that is in the customer's electronic wallet acts as the identifier of the customer and the benefits to which the customer is entitled. The use of the tokens allows the retailer to easily understand that the customer is entitled to the benefits. Some more example use cases of the example embodiments are described in further detail below.

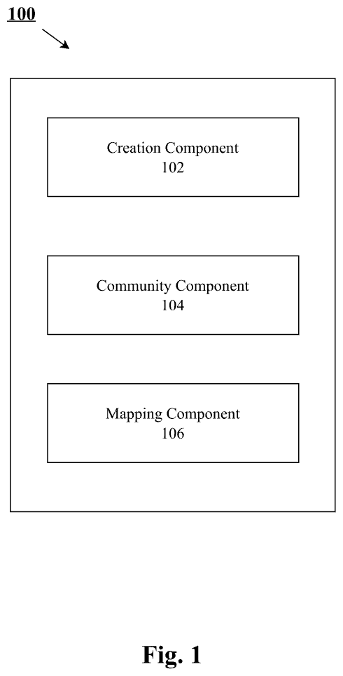

FIG. 1 is a block diagram of an example system 100 according to various example embodiments. According to various example embodiments, the system 100 may be configured to execute any of the described functions herein to instantiate specific system components tailored to execute specific functions. The system 100 may include a crypto creation component 102 that is configured to generate tokens for exchange through the system 100, e.g., gateway tokens and the reward tokens. The tokens may be issued in limited numbers, ensuring that they remain exclusive and valuable. The tokens may be redeemable for fiat currency for the amount paid, but there is no requirement that the tokens be redeemable for cash. As described above, gateway tokens may be used to allow the owner access to certain benefits such as access to an inventory of exclusive items not available to other customers. These exclusive items may be priced in reward tokens which may be used to purchase the exclusive items. Some example use cases of purchasing exclusive items are described in greater detail below.

The system 100 may also include a community component 104 configured to manage registration of community members, qualification of registered users, and compliance with any community requirement. As will be described in greater detail below, access to the customer loyalty program and corresponding gateway tokens may be governed by a set of rules or criteria that allows a user to become a member of the customer loyalty program. The rules may also allow for a user to transfer status via the use of the gateway tokens to another user. The community component 104 may enforce these rules or criteria and allow gateway tokens to be distributed to qualified users and/or transferred to other users.

The system 100 may also include a mapping component 106 configured to generate an encoded mapping associated with a respective token. For example, the mapping component 106 may generate a barcode link to an associated token that will be described in greater detail below.

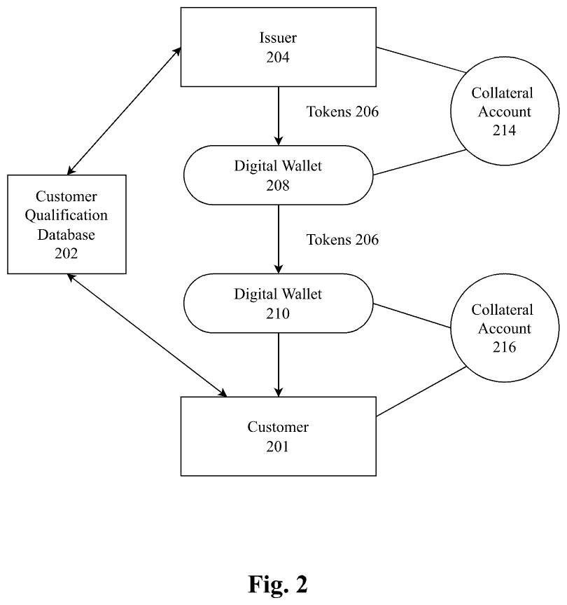

FIG. 2 illustrates the distribution of the cryptocurrency to qualified customers of a customer loyalty program according to various example embodiments. The customers 201 may be vetted for specific qualifications. Again, some specific use cases describing example qualifications will be described in greater detail below. Once qualified, the customers 201 may be stored in a customer qualification database 202 and consumer qualification information may be accessed by the system at any time to ensure that a respective user meets any qualifications for participation. For example, a token issuer 204 may set various requirements on the system.

The issuer 204 may have a digital wallet 208. The issuer 204 may create token(s) 206 that are stored in the issuer digital wallet 208. The token(s) 206 may be transferred by the issuer 204 to a digital wallet 210 of a customer, e.g., customer 201. Each issuer 204 and customer 201 may have respective collateral accounts 214, 216 to meet member requirements or qualifications. In one example, the customer 201 may transfer currency from their collateral account 216 to the collateral account 214 of the issuer 204 for the purposes of purchasing the token(s) 206. Banks, other financial institutions, or redemption centers may interact with the collateral accounts 214, 216 to facilitate hard currency redemption. In some example embodiments, the token(s) 206 may be transferred to the digital wallet 210 of the customer 201 without a corresponding currency transfer, e.g., the token(s) 206 are earned in different manners.

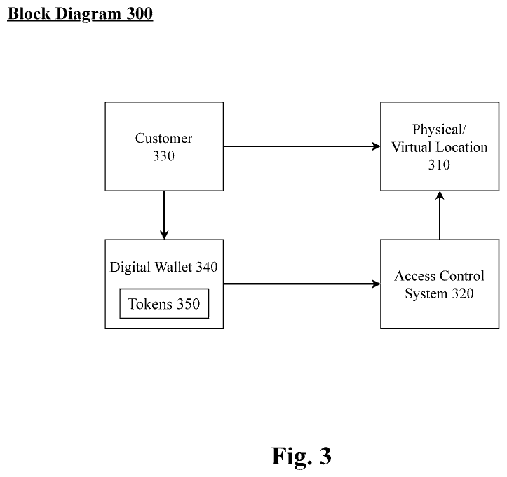

FIG. 3 illustrates a block diagram 300 for using the cryptocurrency to access a physical space according to various example embodiments. In this example, it may be considered that the customer 330 is a qualified customer that is a member of the customer loyalty program of the provider of goods or services. It may further be considered that the provider of goods or services may be the issuer of the currency or, in some examples, the issuer may be a third party that is an administrator of the customer loyalty program for the provider of the goods or services.

The customer 330 may have a digital device such as a smartphone that includes a digital wallet 340 application for holding cryptocurrency (e.g., tokens 350) issued by the provider. In some examples, the digital wallet may be linked to a designated website that verifies the amount of cryptocurrency held by the customer.

As shown in FIG. 3, the provider may have a physical/virtual location 310 such as a brick-and-mortar store. The location 310 may be equipped with one or more wireless-enabled access control systems 320. The wireless-enabled access control system 320 may be, for example, controlled via a short range communication link such as Bluetooth, Zigbee, Ultra-Wideband (UWB), Wi-Fi, Thread, Near-Field Communications (NFC), etc. The wireless-enabled access control system 320 may control access to private spaces 310 within the brick-and-mortar store. These private spaces 310 may be rooms, areas, lockers, display cabinets, etc. The wireless-enabled access control system 320 may allow customers that meet certain requirements (e.g., have a minimum amount of cryptocurrency tokens, have achieved a certain customer loyalty level, etc.) to access these private spaces 310. Some example manners of accessing the private spaces are described below.

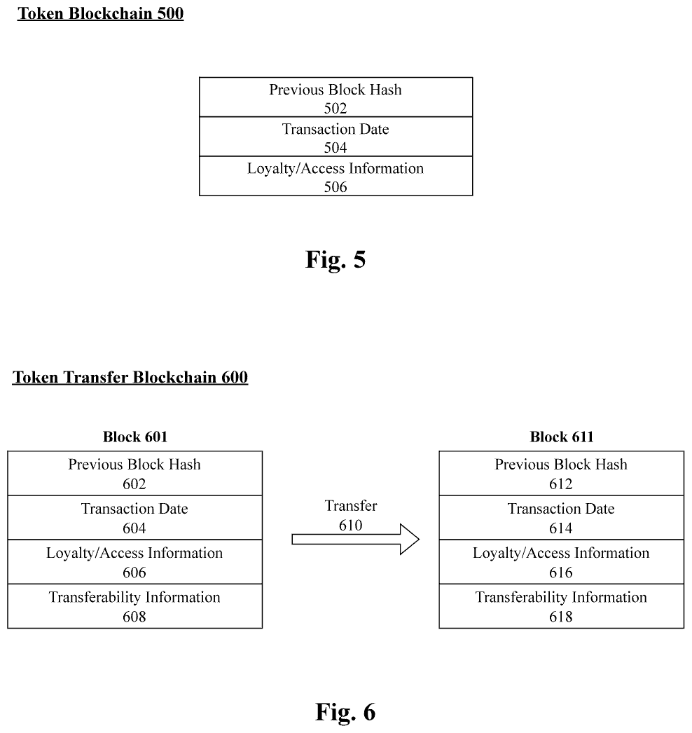

In some example embodiments, the customer's digital wallet 340 application may communicate with the wireless-enabled access control system 320, e.g., the customer's device may allow the digital wallet 340 application to access a communication component (e.g., Bluetooth radio) to transmit information to the wireless-enabled access control system 320. This information may include, for example, an amount of cryptocurrency tokens in the customer's digital wallet, the customer loyalty level, etc. As described above, this information may be information that is encoded on the blockchain of the cryptocurrency tokens. An example of the information is illustrated in FIG. 5.

FIG. 5 shows an example of a token blockchain 500 according to various example embodiments. As shown in FIG. 5, the blockchain 500 may comprise the previous block hash 502, e.g., the hash associated with this token prior to being transferred to the current customer's digital wallet. The blockchain 500 may also comprise the transaction data 504 related to the transaction that resulted in the token being in the digital wallet of the customer. Finally, the blockchain 500 may further comprise the loyalty/access information 506 associated with the token. As described above, in some example embodiments, the token may be a gateway token that records information related to the customer's loyalty status in a customer loyalty program. This loyalty status (e.g., silver, gold, platinum) may correspond to the access status for the customer. In other examples, the token may be a reward token that directly records the access status associated with the token, e.g., the token allows access to the silver room, the gold room, etc. This information 502-506 may then be hashed to generate the token for use by the customer. The information encoded on the blockchain 500 is only an example and other additional information may also be recorded on the blockchain 500.

Returning to FIG. 3, the wireless-enabled access control system 320 may confirm the information encoded in the blockchain of the tokens 350. As described above, in some examples, the information may be directly encoded in the blockchain of the tokens 350. In other example embodiments, the customer's cryptocurrency balance may be verified, e.g., via a linked website described above. If the balance, loyalty status or access status satisfies the rules for access, the wireless-enabled access control system 320 may grant access to the private space 310.

For example, the private space 310 may be equipped with automatic doors/locks that include a short range wireless communication receiver. When the customer 330 with a verified digital wallet 340 approaches, the wireless-enabled access control system may trigger the door to unlock and open. The private areas 310 may, for example, contain merchandise available only to those with sufficient cryptocurrency holdings/status. This creates a premium shopping experience and incentivizes customers to maintain higher balances in their digital wallets.

In other example embodiments, the access control system 320 may be controlled by a scanning system such as a bar code or Quick Response (QR) code scanner. In these example embodiments, the customer 330 may use the mapping component to print out a bar code, QR code or other scannable code with information related to their digital wallet 340, e.g., the number of cryptocurrency tokens, the customer loyalty status, access status associated with tokens, etc. When the customer 330 arrives at the physical location 310, the customer 330 may present the scannable code to a reader that controls access to the physical space 310 in the same manner as described above with respect to the wireless reader.

In some example embodiments, different private spaces may be nested within other private spaces. For example, a first level of cryptocurrency may allow a customer to access a first door to a first private space. Within the first private space may be another door to a second private space. This door may only be accessed by customers with a second level of cryptocurrency, and so on, for as many nested levels/experiences that the provider may desire.

In the above example embodiments, the access described was access to physical locations. However, the locations may also be virtual. For example, the tokens may allow a customer to access a specific page of a provider's website that others cannot access. This private page of the website may include merchandise not available to other customers.

In other examples, the virtual location may be access to an inventory of exclusive items (in a brick and mortar store or in a virtual environment) not available to other customers. These exclusive items may be priced in reward tokens which may be used to purchase the exclusive items or in normal fiat currency.

In either the physical location example or the virtual location example, the validation of the tokens may be verified using a blockchain oracle or decentralized validation server. For example, the provider, when receiving the token(s) from the customer may send the token(s) or information related to the token(s) to a blockchain oracle or decentralized validation server to verify that the token(s) allow the user to access the location.

In some example embodiments, the tokens and/or the loyalty status related to the tokens may be transferred from a customer to another verified customer. FIG. 6 shows an example of a token blockchain transfer 600 according to various example embodiments. The blockchain 600 is similar to the blockchain 500 and may include the previous block hash 602, the transaction data 604 and the loyalty/access information 606. This information 602-606 is similar to the information described above and is not described again. The blockchain 600 further includes transferability information 608. This transferability information records an indication of whether the token (or the loyalty status associated with the token) is transferable to another user. If the transferability information 608 indicates that the token is non-transferable, only the customer that originally earned the token may redeem the access associated with the token.

However, if the transferability information 608 indicates the token is transferable, a customer may transfer the token to another verified customer. In some examples, the other customer may not be initially verified but the transfer may initiate a verification process for the other customer, e.g., similar to the customer verification process described above. In the example of FIG. 6, the token is transferable and a first customer may transfer the token to a second customer.

FIG. 6 shows the blockchain 600 associated with the transfer of the token. The block 601 shows the blockchain when the token is in the possession of the first customer. In transfer 610, the first customer transfers the token from their digital wallet to the digital wallet of the second customer. This causes a new block 611 on the blockchain 600 to be created for the token. Specifically, the block 611 may include the previous block hash 612 (e.g., the block hash associated with the block 601), the transaction data 614 (e.g., the transfer 610 transaction data from the first customer to the second customer), the loyalty/access data 616 and the transferability information 618. In some example embodiments, the token may be freely transferred any number of times, while in other example embodiments the token may be transferred a limited number of times.

Once the token is transferred to the digital wallet of the second customer, the second customer may use the digital token in the same manner as described above, e.g., for access to various locations as recorded in the loyalty/access data 616 of the token.

As stated above with respect to FIG. 5, the information recorded on the blockchain 600 is only an example and other information may also be recorded on the blockchain 600. For example, the blockchain 600 may also record the identity of the customer that is currently holding or has previously held the token in their digital wallet. This information may be used by the provider in the transfer scenario to understand the customer(s) that transferred the token.

Another advantage of using the tokens for granting access to the locations is that because of the blockchain technology, the tokens are tamper resistant. For example, an expiration date may be recorded on the blockchain of the token. This expiration date is immutable and when the date passes, the token is expired and cannot be used. Again, this expiration information is embedded directly in the token itself, so there is no need to reference an outside database or other such system to determine if a token is valid. The digital signatures of the tokens also prevent cloning and the audit trail hashed into the chain allows the provider to understand all the transactions that led to this particular customer possessing the token. Thus, the tokens (and the embedded security features) are a guarantee that there is no misuse of the token. The mere possession of the token is the security that the token is valid. This avoids issues such as replay attacks that could compromise other types of access schemes.

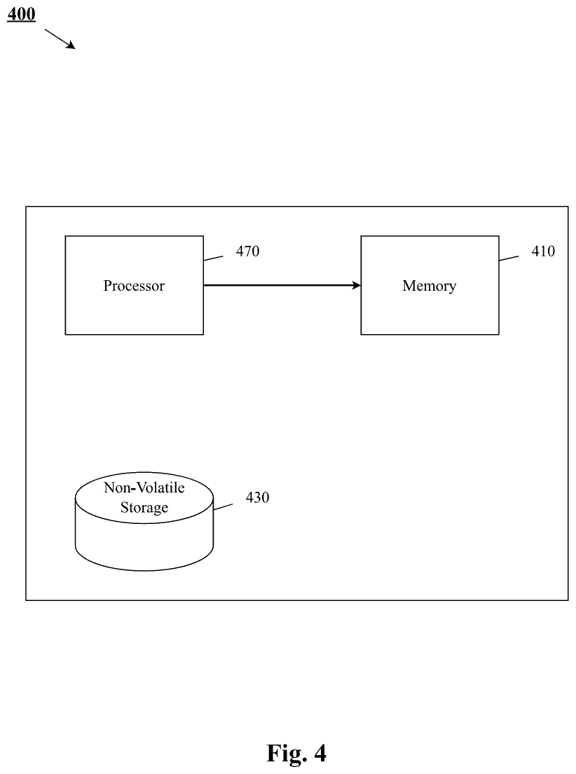

FIG. 4 shows an illustrative implementation of a computer system 400 that may be used in connection with any of the embodiments of the disclosure provided herein. The computer system 500 may include one or more processors 410 and one or more articles of manufacture that comprise non-transitory computer-readable storage media (e.g., memory 420 and one or more non-volatile storage media 430). The processor 410 may control writing data to and reading data from the memory 420 and the non-volatile storage device 430 in any suitable manner. To perform any of the functionality described herein, the processor 410 may execute one or more processor-executable instructions stored in one or more non-transitory computer-readable storage media (e.g., the memory 420), which may serve as non-transitory computer-readable storage media storing processor-executable instructions for execution by the processor 410.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. A system, comprising:
a processor coupled to memory, the processor configured to:
process, based on signals received from a digital wallet of a user, a digital currency unit comprising an indication of an access status associated with the digital currency unit, wherein the access status is recorded on a blockchain of the digital currency unit;
process, based on signals received from the digital wallet of the user, a request to access a location controlled by the system;
verify, based on the digital currency unit, the user is allowed to access the location; and
when it is verified the user is allowed to access the location, generate a signal to grant the user access to the location.

2. The system of claim 1, wherein the location is a physical location.

3. The system of claim 2, further comprising:
an access control device configured to receive the signal and grant the user access to the location.

4. The system of claim 3, wherein the access control device comprises an automatic door that opens when the signal is received.

5. The system of claim 3, wherein the access control device comprises an automatic lock that opens when the signal is received.

6. The system of claim 1, wherein the location is a virtual location.

7. The system of claim 1, wherein the indication of the access status comprises an amount of the digital currency units in the digital wallet.

8. The system of claim 1, wherein the indication of the access status comprises a loyalty status recorded on the digital currency unit.

9. The system of claim 1, wherein the indication of the access status comprises the access status directly recorded on the digital currency unit.

10. The system of claim 1, wherein verifying the user is allowed to access the location comprises the processor being further configured to:
generate, for transmission to a blockchain oracle or decentralized validation server, information related to the digital currency unit; and
receive, from the blockchain oracle or decentralized validation server, a verification that the user is allowed to access the physical space.

11. The system of claim 1, further comprising:
a receiver communicatively coupled to the processor, wherein the receiver receives the signals from the digital wallet of the user.

12. The system of claim 11, wherein the receiver comprises a Bluetooth receiver, a Zigbee receiver, an Ultra-Wideband (UWB) receiver, a Wi-Fi receiver, a Thread receiver, or a Near-Field Communications (NFC) receiver.

13. An apparatus comprising processing circuitry coupled to memory, the processing circuitry configured to:
receive digital currency units associated with a provider;
store the digital currency units in a digital wallet; and
generate, for transmission to an access control system, the digital currency units and a request to allow a user of the digital wallet to access a location controlled by the access control system, wherein the digital currency units comprise an indication of an access status, wherein the access status is recorded on a blockchain of the digital currency unit.

14. The system of claim 13, wherein the location is a physical location or a virtual location, wherein the physical location or virtual location comprises goods or services sold by the provider to users that access the location.

15. The system of claim 13, further comprising:
transceiver circuitry configured to transmit signals to the access control system, wherein the transceiver circuitry comprises circuitry to transmit a Bluetooth signal, a Zigbee signal, an Ultra-Wideband (UWB) signal, a Wi-Fi t signal, a Thread signal, or a Near-Field Communications (NFC) signal.

16. The system of claim 13, wherein the indication of the access status comprises an amount of the digital currency units in the digital wallet.

17. The system of claim 13, wherein the indication of the access status comprises a loyalty status recorded on the digital currency unit.

18. The system of claim 13, wherein the indication of the access status comprises the access status directly recorded on the digital currency unit.

19. The system of claim 13, wherein the digital currency units associated with the provider are received from one of a) the provider, b) a third party entity associated with the provider or c) a customer of the provider.

20. The system of claim 19, wherein, when the digital currency units are received from the customer of the provider, the digital currency units further comprise a transferability indication indicating the digital currency units are transferable between customers.
